(19) United States
(12) Patent Application Publication
(10) Pub. No.: US 2009/0241584 A1
(43) Pub. Date: Oct. 1, 2009

(54) MULTI-SPIGOT COOLER

(75) Inventors: Andrew Hayes, Concord, NC (US); Andrew Logar, Willowick, OH (US)

Correspondence Address: MOORE & VAN ALLEN PLLC, P.O. BOX 13706, Research Triangle Park, NC, 27709, US

(73) Assignee: RUBBERMAID INCORPORATED, Huntersville, NC (US)

(21) Appl. No.: 12/055,833

(22) Filed: Mar. 26, 2008

(51) Int. Cl. B67D 5/34; B67D 5/62

(52) U.S. Cl. 62/390; 62/457.1; 222/1; 220/592.18

(57) ABSTRACT

A cooler has a thermally insulated container that defines a reservoir for retaining a flowable substance or fluid and comprises a base and a perimeter sidewall upwardly extending from the base to define an internal reservoir. The cooler also has at least a first spigot and a second spigot. The first spigot is rigidly attached to the perimeter sidewall at a first location and the second spigot is rigidly attached to the perimeter sidewall at a second location. The first location is spaced apart from said second location.

### BACKGROUND

Coolers for dispensing liquids are known. A typical cooler comprises a container having an insulated outer wall. A removable cover may be provided for allowing the container to be filled and/or emptied. A spigot is provided near the bottom of the container for dispensing the liquid form the cooler by activation of a push button control lever or the like.

An improved cooler is disclosed.

### SUMMARY

Embodiments of the present invention are directed to cooler. The cooler has a thermally insulated container defining a reservoir for retaining a flowable substance and comprising a base and a perimeter sidewall extending from the base. The perimeter sidewall comprises a first portion and a second portion that are defined by a plane intersecting the perimeter sidewall. The cooler further comprises at least a first spigot and a second spigot. The first spigot is rigidly attached to the perimeter sidewall at a first location in the first portion and the second spigot is rigidly attached to the perimeter sidewall at a second location, where the first location is spaced apart from the second location.

In addition, embodiments of the present invention are directed to a thermally insulated container that defines a reservoir for retaining a flowable substance. The container comprises a base and a perimeter sidewall upwardly extending around the base and defines a center of gravity. The perimeter sidewall comprises a first portion and a second portion that are defined by a vertical plane intersecting the perimeter sidewall and the center of gravity. The container further comprises at least a first spigot and a second spigot. The first spigot is rigidly attached to the perimeter sidewall at a first location in the first portion and the second spigot is rigidly attached to the perimeter sidewall at a second location in the first portion. The first location is spaced apart from the second location and the at least first and second spigots are attached only in the first portion.

In addition, embodiments of the present invention are directed to a method for dispensing liquid from a cooler. The method comprises providing a cooler that comprises a thermally insulated container that defines a reservoir for retaining a flowable substance and comprises a base and a perimeter sidewall upwardly extending from the base. The cooler further comprises at least a first spigot and a second spigot. The first spigot is rigidly attached to the perimeter sidewall at a first location and the second spigot is rigidly attached to the perimeter sidewall at a second location, where the first location is spaced apart from said second location. The method further comprises placing the cooler on a horizontal surface, placing a first object directly underneath the first spigot, and actuating the first spigot.

In addition, embodiments of the present invention are directed to an apparatus that comprises a thermally insulated container that defines a reservoir for retaining a flowable substance and comprises a base and a perimeter sidewall upwardly extending from the base. The apparatus further comprises at least a first spigot and a second spigot. The first spigot is rigidly attached to the perimeter sidewall at a first location and the second spigot is rigidly attached to the perimeter sidewall at a second location, where the first location is spaced apart from said second location.

In addition, embodiments of the present invention are directed to a liquid dispensing device that comprises a container having a vertical sidewall. The liquid dispensing device further comprises a first conduit in fluid communication with the sidewall at a first location and a first valve in fluid flow communication with the first conduit. The liquid dispensing device further comprises a second conduit in fluid communication with the sidewall at a second location and a second valve in fluid flow communication with the second conduit.

### BRIEF DESCRIPTION OF THE DRAWINGS

FIG. 1 is a front view of one embodiment of the cooler of the present invention with two spigots.

FIG. 2 is a top view of the cooler of FIG. 1 with the cooler lid removed.

FIG. 3 is a front view of another embodiment of the cooler of the present invention with three spigots.

FIG. 4 is a top view of the cooler of FIG. 3 with the cooler lid removed.

FIG. 5 is a front view of another embodiment of the cooler of the present invention with four spigots.

FIG. 6 is a top view of the cooler of FIG. 5 with the cooler lid removed.

FIG. 7 is a perspective view of an exemplary spigot that may be attached to the cooler of the present invention.

FIG. 8 is a top view of the spigot of FIG. 7.

FIG. 9 is a section view taken along line 8-8 of FIG. 8.

FIG. 10 is a flow chart of an example of a method for operation of the cooler of the present invention.

### DETAILED DESCRIPTION OF EMBODIMENTS OF THE INVENTION

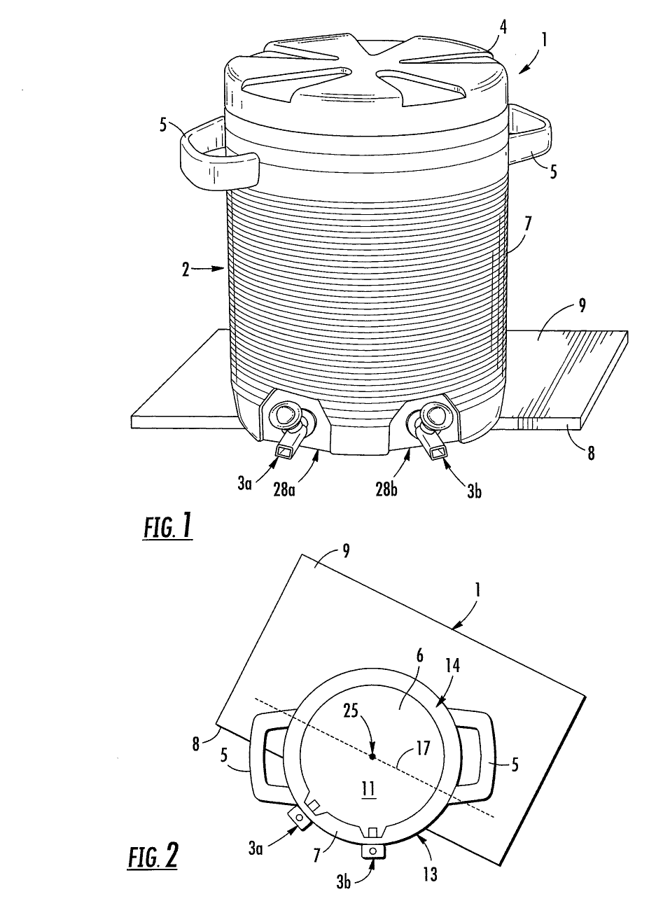

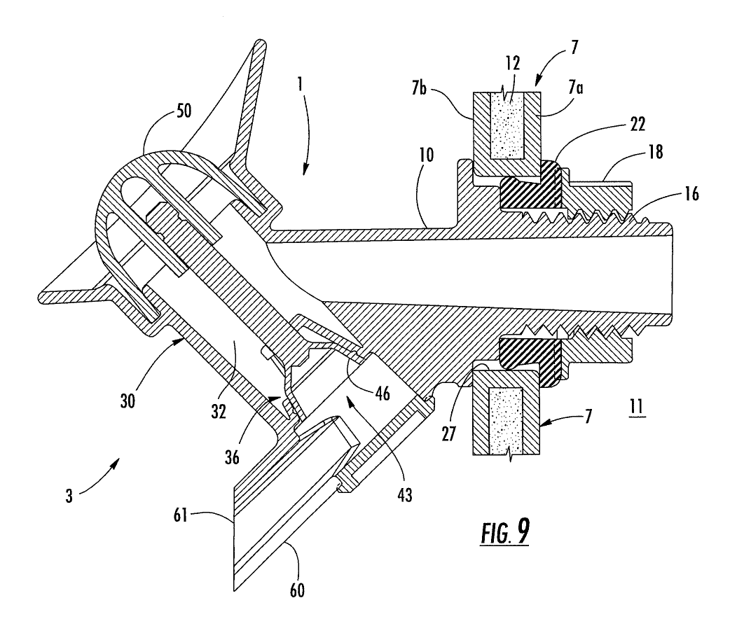

Referring generally to FIGS. 1-9, various embodiments of the cooler of the invention are generally shown at 1 in FIGS. 1-6 and various embodiments of spigots 3a-3d of cooler 1 are shown in FIGS. 7-9. Cooler 1 comprises a container 2, a plurality of spigots 3a-3d, a removable lid 4 for filling container 2 and handles 5 for carrying cooler 1.

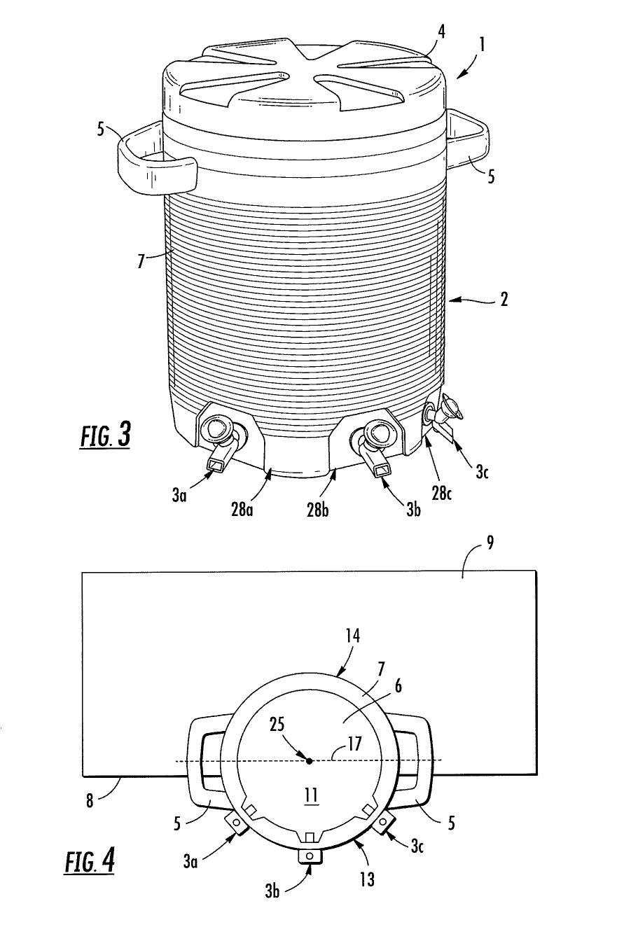

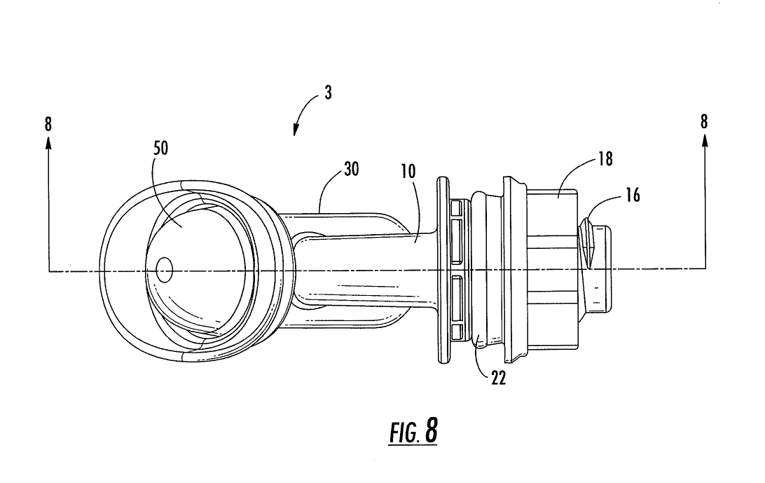

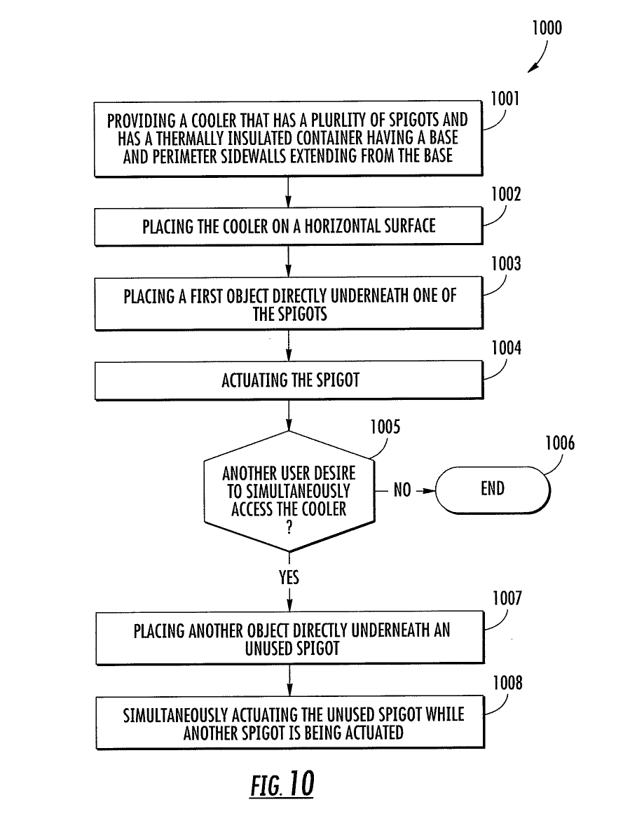

Container 2 may be any container having an interior reservoir 11 therein which is sufficiently voluminous so as to hold liquids in bulk. Container 2 has a base 6 and an upstanding sidewall 7 extending vertically around the perimeter of base 6 so as to define an interior reservoir 11. Sidewall 7 may be a single member composed of a plastic, metal or a polymer material or sidewall 7 may comprise two or more layers 7a and 7b, including an insulating layer 12, as shown in FIG. 9. Insulating layer 12 may be a layer of air or a thermally insulating composition. Container 2 is made up of a first portion 13 and a second portion 14 defined by a vertical plane 17 that extends perpendicularly from base 6. Vertical plane 17, depicted by line 17 in the illustrated embodiments, intersects sidewall 7 at the approximate center of gravity 25 of container 2. The center of gravity 25 of cooler 1 may be located in the center of base 6, as shown in FIGS. 2 and 4, or may be located away from the center of base 6, as shown in FIG. 6.

Container 2 is commonly used to hold and dispense any substantially viscous substance. Container 2 may be any container where using a spigot 3a-3d to dispense fluids is desired, including coolers, cartons, bottles, tubs, boxes, or the like. Furthermore, container 2 may be of any shape, (e.g. cylindrical, round, square, rectuangler and the like) or size (e.g. a ten gallon cooler, a five gallon cooler and the like).

Cooler 1 may also include two or more spigots. Spigots 3a-3d are manually activated valves capable of dispensing a fluid in a controlled fashion. Such spigots 3a-3d dispense the liquid by allowing gravity to drain the liquid from the container 2 when the spigot 3a-3d is opened. Referring to FIGS. 7-9, each spigot 3a-3d comprises a conduit 10 that communicates with the interior reservoir 11 of the container 2. Conduit 10 communicates with a spigot valve body 30 that comprises a chamber 32 that includes an opening 43 that is selectably opened and closed by a valve element 46. Valve element 46 may be movable into and out of engagement with a valve seat 36 formed around opening 43. Valve element 46 may be biased to the closed position by a spring such as an elastomeric diaphram 50. Elastomeric diaphram 50 may seal chamber 32 and be exposed such that depressing diaphram 50 moves valve element 46 from the normally closed position to an open position. The valve body 30 may be disposed such that it extends from the first conduit 10 at an angle. The opening in the valve body 30 communicates with a second conduit 60 that extends from the valve body 30 to receive the flow of fluid and dispense the fluid via opening 61. Suitable spigots 3a-3d are shown in U.S. Pat. No. 4,452,425 issued on Jun. 5, 1984 to Lucking, U.S. Pat. No. 4,742,851 issued on May 10, 1988 to Lundblade, and U.S. patent application Ser. No. 11/538,254 filed on Oct. 3, 2006 by Charles William Craft, all of which are herein incorporated by reference in their entirety. Other spigot designs may also be used.

Each spigot 3a-3d is rigidly attached to sidewall 7 via an aperture 27 in the sidewall 7. Each aperture 27 allows each spigot 3a-3d to be in fluid flow communication with the interior reservoir 11.

Each spigot 3a-3d may be mechanically fastened to sidewall 7 to form a watertight seal. A gasket or grommet 22 composed of deformable or compressible material may be placed over the conduit 10. A nut 18 composed of a generally rigid and non-compressible material, one example being polypropylene, is threaded onto complimentary threads 16 along the conduit 10 and tightened to compress the gasket 22 between nut 18 and sidewall 7 and retain the spigot in the sidewall 7.

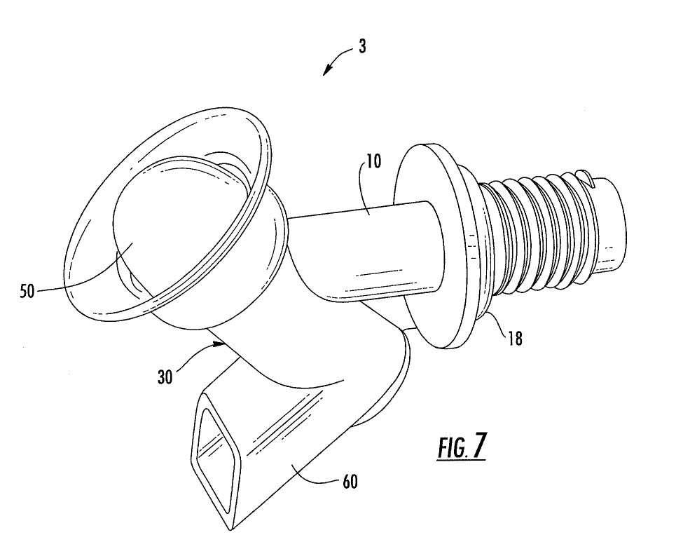

The maximum number of spigots 3a-3d for container 2 is generally related to the circumference of container 2. Spacing between the spigots 3a-3d should be sufficient so as to allow a user to manually operate each spigot 3a-3d and dispense fluid without interfering with the use of adjacent spigots 3a-3d. In one preferred embodiment, spigots 3a-3d are disposed about the the base 6 of container 2 with at least four inches between spigots 3a-3d. Spigots 3a-3d may be positioned on the container 2 so as to be disposed a distance from base 6. As illustrated with reference to spigot 3b in FIG. 5, each spigot may be positioned along a first distance D1 that is near base 6 of container 2, so as to maximize the gravity-fed flow of fluid therefrom. In another embodiment, one or more spigots, as illustrated by spigot 3c in FIG. 5, may be disposed a greater distance D2 from base 6 than the first distance D1 of the other spigots 3a, 3b and 3d. Placing the spigots at different distances from the base 6 provides suitable physical separation between the spigots during use.

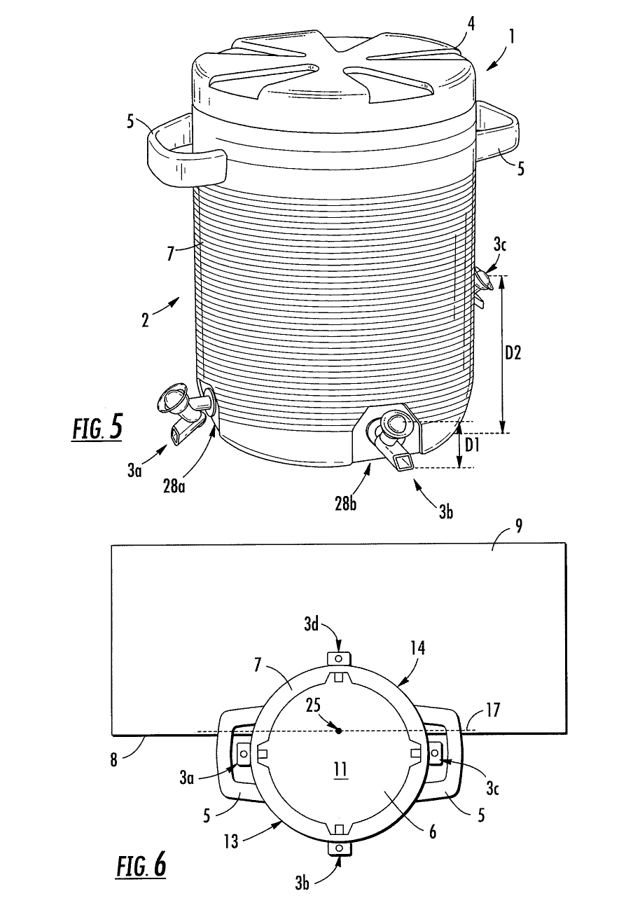

Various configurations of the locations of spigots 3a-3d about the perimeter sidewall 7 are possible. In one exemplary embodiment as shown in FIGS. 1-2, a first spigot 3a and a second spigot 3b may be attached to the first portion 13 of perimeter sidewall 7 at a first location and second location, respectively. In another exemplary embodiment, first spigot 3a, second spigot 3b and third spigot 3c may be attached to the first portion 13 of perimeter sidewall 7 at first, second and third locations, respectively, as illustrated in FIGS. 3-4. In yet another exemplary embodiment as shown in FIGS. 5-6, first spigot 3a, second spigot 3b, third spigot 3c and fourth spigot 3d may be connected to perimeter sidewall 7, with the first spigot 3a and second spigot 3b attached to the first portion 13 at first and second locations and the third spigot 3c and fourth spigot 3d attached to the second portion 14 at third and fourth locations, respectively. In any of the previous embodiments, all of the spigots of container 2 may be disposed only in the first portion 13 such that no spigots are attached to the second portion 14 or the spigots may be located in both the first and second portions 13 and 14.

Spigots 3a-3d may be located within recesses 28a-28d so as to minimize their projection beyond the exterior surface of the wall 7 or flush mounted to the wall 7 so as to project therefrom.

Cooler 1 may also comprise a removable lid 4 for filling the container 2. Lid 4 is generally shaped so as to completely cover and close an open end of container 2. Lid 4 may be of any shape to fit the open end of container 2. Lid 4 is releasably attached at one end of container 2 such as by threads, compression fit, locking mechanisms or the like. For example, lid 4 may be threaded to match complimentary threads along sidewall 7 so as to be threaded onto container 2 or lid 4 may simply plug into the open end of container 2. Typically, lid 4 is also thermally insulated.

Cooler 1 may additionally comprise one or more handles 5 for carrying container 2. These handles 5 may be attached to or molded into the sidewall 7. Handles 5 should be sufficient to support the full weight of container 2 when container 2 is filled with a substance.

Cooler 1 is constructed so that it may freely rest on any surface 9 that has an edge 8. Surface 9 may be any elevated surface having a surface area such that a portion of cooler 1 may be allowed to hang off edge 8 of surface 9. This allows one or more spigots 3a-3d attached to the portion hanging off edge 8 so no obstruction is disposed directly underneath one or more of spigots 3a-3d. In this configuration, simultaneous, unobstructed access to one or more spigots 3a-3d is permitted. In one embodiment, cooler 1 may freely rest on edge 8 such that no external forces need be applied to cooler 1 to keep the cooler 1 stable on edge 8 and while allowing simultaneous, unobstructed access to a plurality of spigots 3a-3d. Additionally, the center of gravity 25 of cooler 1 (while cooler 1 may be filled with liquid) should be placed on surface 9 such that the center of gravity 25 may be supported by surface 9.

As shown in the illustrated embodiment of FIGS. 1-2, a portion of base 6 of cooler 1 hangs off edge 8 of surface 9 such that the area below spigots 3a and 3b may be unobstructed. The center of gravity 25 of cooler 1 is supported by surface 9 such that cooler 1 can stably rest on surface 9. As shown, first spigot 3a and second spigot 3b are attached near the base 6 of cooler 1. This allows simultaneous access to the fluid in the interior reservoir 11 of cooler 1 by concurrently actuating first spigot 3a and second spigot 3b. As shown in FIGS. 2 and 4, all of the spigots (3a-b of FIG. 2 and 3a-c of FIG. 4) of cooler 1 may be disposed in the first portion 13 of cooler 1 such that all of the spigots of cooler 1 may be accessed simultaneously while the cooler is resting on the edge 8 of surface 9. As shown in FIGS. 2 and 4, no spigots may be attached to second portion 14 where surface 9 may be disposed directly underneath such that a user may have unobstructed access to every spigot that is connected to cooler 1. Although FIGS. 1-4 show that no spigots are attached to second portion 14, FIG. 6 shows that one or more spigots, such as spigot 3d, may be attached to second portion 14 even though second portion 14 may have surface 9 disposed directly underneath spigot such that access to spigot 3d may be obstructed. In the case that a surface is disposed underneath a spigot, FIG. 6 shows that a spigot 3c may be elevated a distance D2 from base 6 such that the surface 9 disposed under spigot 3d does not prevent spigot 3d from being obstructed by surface 9. Also, cooler 1, as shown in FIG. 6, may be placed on a pedestal where all of the spigots may be accessed simultaneously. In allowing simultaneous access to all of the spigots, placing the spigots at different distances from the base 6, as previously discussed with respect to raised spigot 3c of FIG. 5, facilitates multiple user access to the cooler 1 by providing greater physical separation between spigots.

Referring to FIG. 10, a cooler having a plurality of spigots, as previously described with regard to FIGS. 1-9, is provided (step 1001) and placed on a horizontal surface (step 1002) such that one or more spigots hangs over the edge of the surface. A user may then place an object, such as a cup, directly underneath one of the spigots (step 1003) and actuate the spigot (step 1004), giving the user access to the interior reservoir of the cooler. If a user wants to simultaneously access the interior reservoir of cooler (step 1005), then the user places another object directly under one of the unused spigots (step 1007) and actuates the unused spigot (step 1008). The method (1000) of FIG. 10 is repeated for all simultaneous users until no users decide to simultaneously access the cooler. At that point, the method (1000) may terminate (step 1006).

Specific embodiments of an invention are described herein. One of ordinary skill in the art will recognize that the invention has other applications in other environments. In fact, many embodiments and implementations are possible. The following claims are in no way intended to limit the scope of the invention to the specific embodiments described above.

What is claimed is:

1. An apparatus comprising:
a thermally insulated container defining a reservoir for retaining a flowable substance and comprising a base and a perimeter sidewall extending from said base, said perimeter sidewall comprises a first portion and a second portion that are defined by a plane intersecting said perimeter sidewall; and
at least a first spigot and a second spigot, wherein said first spigot is rigidly attached to said perimeter sidewall at a first location in said first portion and said second spigot is rigidly attached to said perimeter sidewall at a second location;
wherein said first location is spaced apart from said second location.

2. The apparatus according to claim 1, wherein said second location is located in said second portion.

3. The apparatus according to claim 1, wherein said second location is located in said first portion.

4. The apparatus according to claim 3, further comprising a third spigot rigidly attached to said perimeter sidewall at a third location, said third location being spaced from said first location and said second location.

5. The apparatus according to claim 4, wherein said third location is located in said first portion.

6. The apparatus according to claim 4, further comprising a fourth spigot rigidly attached to said perimeter sidewall at a fourth location, wherein said third location and said fourth location are located in said second portion.

7. The apparatus according to claim 1, wherein said perimeter sidewall further comprises an inner surface and an outer surface, said inner surface and said outer surface being thermally insulated therein.

8. The apparatus according to claim 4, wherein each of said first, second and third spigots is in communication with said reservoir and comprises an actuation means and a valve.

9. The apparatus according to claim 1, further comprising a lid capable of attaching to said container.

10. The apparatus according to claim 1, wherein said spigot comprises:
a conduit extending through said perimeter sidewall and in fluid communication with said reservoir;
a valve in fluid flow communication with said conduit.

11. The apparatus according to claim 1, wherein said plane defines a first half and a second half of said cooler such that said first portion is said first half of said perimeter sidewall and said second portion is said second half of said perimeter sidewall.

12. A cooler comprising:
a thermally insulated container defining a reservoir for retaining a flowable substance and comprising a base and a perimeter sidewall upwardly extending around said base and defining a center of gravity, wherein said perimeter sidewall comprises a first portion and a second portion that are defined by a vertical plane intersecting said perimeter sidewall and said center of gravity; and
at least a first spigot and a second spigot, wherein said first spigot is rigidly attached to said perimeter sidewall at a first location in said first portion and said second spigot is rigidly attached to said perimeter sidewall at a second location in said first portion;
wherein said first location is spaced apart from said second location; and
wherein said at least said first spigot and said second spigot are attached only in said first portion.

13. The cooler according to claim 12, further comprising a third spigot rigidly attached to said perimeter sidewall at a third location in said first portion, wherein said third location is spaced apart from said first and second locations.

14. The cooler according to claim 12, wherein at least one of said at least said first spigot and second spigot are located a first distance from said base.

15. The cooler according to claim 14, wherein at least one of said at least said first spigot and second spigot are located a second distance from said base, wherein said second distance is greater than said first distance.

16. A method for dispensing liquid from a cooler, comprising:
providing a cooler comprising:
a thermally insulated container defining a reservoir for retaining a flowable substance and comprising a base and a perimeter sidewall upwardly extending from said base; and
at least a first spigot and a second spigot, wherein said first spigot is rigidly attached to said perimeter sidewall at a first location and said second spigot is rigidly attached to said perimeter sidewall at a second location;
wherein said first location is spaced apart from said second location;
placing said cooler on a horizontal surface;
placing a first object directly underneath said first spigot; and
actuating said first spigot.

17. The method according to claim 16, further comprising:
placing a second object directly underneath said second spigot; and
actuating said second spigot.

18. The method according to claim 17, wherein said actuating said second spigot occurs simulataneously with said actuating said first spigot.

19. The method according to claim 16, wherein said cooler further comprises a third spigot rigidly attached to said perimeter sidewall at a third location, wherein said third location is spaced apart from said first and second locations.

20. The method according to claim 19, further comprising:
placing a second object directly underneath said second spigot;
placing a third object directly underneath said third spigot; and
actuating at least one of said second and third spigots;
wherein said actuating said at least one of said second and third spigots occurs simulataneously with said actuating said first spigot.

21. An apparatus comprising:
a thermally insulated container defining a reservoir for retaining a flowable substance and comprising a base and a perimeter sidewall extending from said base; and
at least a first spigot and a second spigot, wherein said first spigot is rigidly attached to said perimeter sidewall at a first location and said second spigot is rigidly attached to said perimeter sidewall at a second location;
wherein said first location is spaced apart from said second location.

22. The apparatus of claim 21, wherein said first location comprises a first aperature in said perimeter sidewall in fluid flow communication with said first spigot and said second location comprises a second aperature in fluid flow communication with said second spigot.

23. The apparatus of claim 21, further comprising a third spigot rigidly attached to said perimeter sidewall at a third location, said third location being spaced apart from said first and second locations.

24. The apparatus of claim 23, further comprising a fourth spigot rigidly attached to said perimeter sidewall at a fourth location, said fourth location being spaced apart from said first, second and third locations.

25. A liquid dispensing device comprising:
a container having a vertical sidewall;
a first conduit in fluid communication with said sidewall at a first location;
a first valve in fluid flow communication with said first conduit;
a second conduit in fluid communication with said sidewall at a second location; and
a second valve in fluid flow communication with said second conduit.

26. The liquid dispensing device of claim 25, further comprising:
a third conduit in fluid communication with said sidewall at a third location; and
a third valve body in fluid flow communication with said third conduit.
